(19) United States
(12) Patent Application Publication
(10) Pub. No.: US 2007/0030854 A1
(43) Pub. Date: Feb. 8, 2007

(54) Method and Apparatus for Exchanging Signals with a Computer System through Wired and Wireless Communication in an Input Device of the Computer System

(76) Inventors: Bi-Hui Lin, Hsin-Chu Hsien (TW); Chin-Chou Lee, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,953

(22) Filed: Dec. 12, 2005

(30) Foreign Application Priority Data
Aug. 2, 2005 (TW) 094126224

(51) Int. Cl. H04L 12/56

(52) U.S. Cl. 370/401; 340/3.1; 370/310

(57) ABSTRACT

A method for exchanging signals with a computer system through a wired and wireless communication in an input device of the computer system includes determining whether the input device connects to the computer system through a wire or not, and exchanging signals with the computer system through wireless communication when the input device cannot connect to the computer system through the wire.

### BACKGROUND OF THE INVENTION

1. Field of the Invention

The present invention relates to a method and apparatus for exchanging signals with a computer system through a wired and wireless communication in an input device of the computer system, more particularly, an input device capable of selectively switching to a wired communication or a wireless communication for operating in a wired transmission mode and charging a rechargeable battery from power obtained from the computer system when the input device is connected to the computer system via a wire, and the input device for operating in a wireless transmission mode and utilizing the power supplied from an internal power source when the input device cannot connect to the computer system through the wire.

2. Description of the Prior Art

From traditional functions, such as document processing and program operating, to modern multimedia, computer games, etc., a personal computer (PC) has come to serve an important role in our daily lives. The mouse and keyboard used for controlling the PC have improved too. In a conventional transmission method, the current mouse and keyboard can be categorized into the two groups: wired or wireless. In addition, with wireless communication technology, a traditional mouse, which transmits signals to a computer system with physical wires, can be replaced by a wireless mouse. However, the wired mouse and the wireless mouse each have its advantages. Owing to limitations of wireless communication, a report rate of the prior art wireless mouse cannot match the same level as the wired mouse. The word “report” of the report rate means that the wireless mouse transmits detected displacement and switch statuses to the computer system, while report per second, or RPS, is a term used to count the report rate, meaning how many signal counts are transmitted to the computer each second. As the RPS grows larger, the moving consistency between a cursor displayed on the monitor and the mouse in a user's hand will correspondingly increase. In general, the report rate of a wired USB mouse is between 100 Hz and 125 Hz, which is between 100 and 125 report counts per second. Alternatively, the report rate of the wireless mouse is between 60 Hz and 80 Hz. Therefore, the user can feel (i.e., notice and be aware of) an obvious difference between the wired mouse and the wireless mouse, especially when utilizing fast moving operations, such as with PC games, drafting, and web surfing applications.

The report rate of the wired mouse is greater than the wireless mouse, however as the wired mouse must be connected to the computer system through a physical cable, the length of the physical cable limits the freedom of movement of the wired mouse. In comparison to the wired mouse, the physical wire does not limit the movement of the wireless mouse and hence there is less inconvenience to the user. However, without the physical wire, the wireless mouse requires a power supply device independent from the PC. Although the wireless mouse can provide a user with more freedom and convenience in usage, the user is now required to consider the issue of power and specifically, when the wireless mouse exhausts it's power, and therefore the wireless mouse is unable to function. Furthermore, in some circumstances, the metallic shield or other low frequency signal transmitters can affect the proper operation of the wireless mouse or even causes the wireless mouse to stop functioning.

Regarding the keyboard, if a distance between a wired keyboard and the main computer component (PC) is significantly great, then a wire of the keyboard must be extended, but in doing so, a longer wire will affect the signal transmission. Additionally, the longer wire appears messy (i.e., tangled). A wireless keyboard can solve the above-mentioned problems, but like the wireless mouse, the wireless keyboard encounters the same power problem and is also affected by metallic shield and other low frequency signal transmitters, which may cause the wireless mouse, in this case the wireless keyboard, to stop functioning. Therefore, if a keyboard or mouse can selectively switch between a wired communication and wireless communication when required, then the keyboard or mouse comprises the advantages of wired transmission and wireless transmission; hence the problems of the above-mentioned can be solved.

### SUMMARY OF THE INVENTION

Therefore, the main objective of the claimed invention is to provide a method and related device for exchanging signals with a computer system through a wired communication and wireless communication in an input device of a computer system.

The claimed invention discloses a control chip for exchanging signals with a computer system through a wired and wireless communication in an input device of the computer system including a wireless transmission module for exchanging signals with the computer system through the wireless communication, a wired transmission module for exchanging signals with the computer system through a wire, and a transmission mode decision module coupled to the wireless transmission module and the wired transmission module for selecting a transmission module from either the wireless transmission module or the wired transmission module to exchange signals with the computer system according to a control signal.

The claimed invention further discloses a signal process device for exchanging signals with a computer system through a wired and wireless communication in an input device of the computer system including a sensing circuit for determining data received by the input device, a packet forming circuit coupled to the sensing circuit for forming a plurality of packets according to signals outputted from the sensing circuit, and a control chip coupled to the packet forming circuit for transmitting the plurality of packets outputted from the packet forming circuit to the computer system, the control chip includes a wireless transmission module for exchanging signals with the computer system through the wireless communication, a wired transmission module for exchanging signals with the computer system through a wire, and a transmission mode decision module coupled to the wireless transmission module and the wired transmission module for selecting a transmission module from either the wireless transmission module or the wired transmission module to exchange signals with the computer system according to a control signal.

The claimed invention further discloses an input device capable of exchanging signals with a computer system through a wired and wireless communication including a housing, a sensing circuit installed within the housing for determining data received by the input device, a packet forming circuit installed within the housing and coupled to the sensing circuit for forming a plurality of packets according to signals outputted from the sensing circuit, a control chip installed within the housing and coupled to the packet forming circuit for transmitting the plurality of packets outputted from the packet forming circuit to the computer system, an antenna installed within the housing and coupled to the wireless transmission module, and a power module installed within the housing for providing power. The control chip includes a wireless transmission module for exchanging signals with the computer system through the wireless communication, a wired transmission module for exchanging signals with the computer system through a wire, and a transmission mode decision module coupled to the wireless transmission module and the wired transmission module for selecting a transmission module from either the wireless transmission module or the wired transmission module to exchange signals with the computer system according to a control signal.

The claimed invention further discloses a method of exchanging signals between an input device and a computer system through a wireless communication and a wired communication, the method including determining whether the input device is connected to the computer system through a wire, and exchanging signals with the computer system through the wireless communication when the input device is not connected to the computer system through the wire.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a flow of an input device of a computer system exchanging signals with the computer system through a wireless communication and a wired communication.

FIG. 2 illustrates a functional block diagram of a control chip for exchanging signals between an input device of a computer system and the computer system itself through a wired communication and a wireless communication.

FIG. 3 illustrates a functional block diagram of a signal process device for exchanging signals between an input device of a computer system and the computer system through a wired communication and a wireless communication.

FIG. 4 illustrates a diagram of the present invention application.

FIG. 5 illustrates a diagram of a wireless transmission module according to another embodiment of the wireless transmission module of FIG. 3.

### DETAILED DESCRIPTION

The present invention utilizes an input device of a computer system capable of selectively switching between a wired communication or wireless communication when required, the input device comprises only the advantages of a wired input device and a wireless device without the disadvantage of the wired input device or the wireless device.

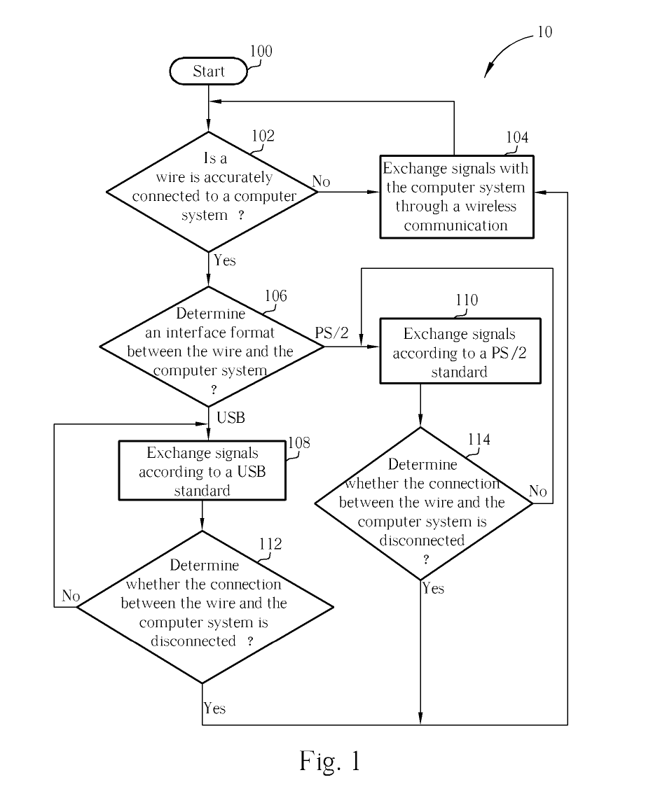

Please refer to FIG. 1. FIG. 1 illustrates a flowchart of a flow 10 of an input device of a computer system exchanging signals with the computer system through a wireless communication and a wired communication. The input device can be a keyboard, a mouse or equivalent electronic input devices of the computer system. The flow 10 comprises the following steps:

Step 100: Start, when power of the input device initiate, begin the flow 10;

Step 102: Determine whether a wire is accurately connected to the computer system, if the input device is accurately connected to the computer system through the wire, execute step 106, otherwise, if the input device cannot connect to the computer system through the wire, then execute step 104;

Step 104: Exchange signals with the computer system through the wireless communication and continue to check whether the wire is connected to the computer system (execute step 102);

Step 106: Determine an interface format between the wire and the computer system, if the interface format utilizes a USB, then process to step 108, if the interface format is PS/2, then proceed to step 110;

Step 108: Exchange signals according to the USB standard, and execute step 112;

Step 110: Exchange signals according to the PS/2 standard, and execute step 114;

Step 112: Determine whether the connection between the wire and the computer system is disconnected, if so, execute step 104, if the connection still exists, proceed back to step 108;

Step 114: Determine whether the connection between the wire and the computer system is disconnected, if so, execute step 104, if the accurate connection still exists, return to step 110.

Therefore, after the power is initiated, the flow 10 of the present invention first checks to determine if the input device is accurately connected to the computer system through the wire. If the input device is accurately connected to the computer system through the wire, then the flow 10 sets the transmission of the input device to wired transmission. Otherwise, if the input device cannot connect to the computer system through the wire (such as the cable is loose, the cable is not inserted into the computer system or other faults), then the present invention sets the transmission of the input device to wireless transmission, thus a user can enjoy more freedom and convenience while utilizing the input device without the restrictions due to the length of the wire. In other words, when the user inserts the wire of the input device into the computer system, the flow 10 will set an operational mode of the input device to the wired transmission, and when the wire is not yet inserted into the computer system, the operational mode will then be set to the wireless transmission. Alternatively, when the wire connects to the computer system, the present invention can check the interface format (such as PS/2 and USB) between the wire and the computer system and exchange signals according to the appropriate interface format. Please note that those skilled in the art are well aware of the functions of the PS/2 and the USB and their respective possible changes and combinations, such as during a wired transmission, a wireless transmission protocol can be utilized to connect to a wireless signal receiver via a physical cable.

Therefore, the user can select the appropriate operational mode according to the present requirement. For example, when the input device is a mouse, if the user prefers a smoother operation, the user can insert the wire into the computer system, or when the user requires more freedom and convenience, the user can just unplugged the wire from the computer system. Please note that the wireless input device is independent from the power supply of the computer system, therefore in the present invention, a battery within the input device can be charged when the wire of the input device is connected with the computer system.

In general, the flow 10 can set the transmission mode of the input device to the wired transmission when the wire of the input device accurately connects to the computer system, and the flow can set the transmission mode of the input device to the wireless transmission when the wire cannot accurately connect to the computer system. Hence, the user can select the operational mode according to the current requirement.

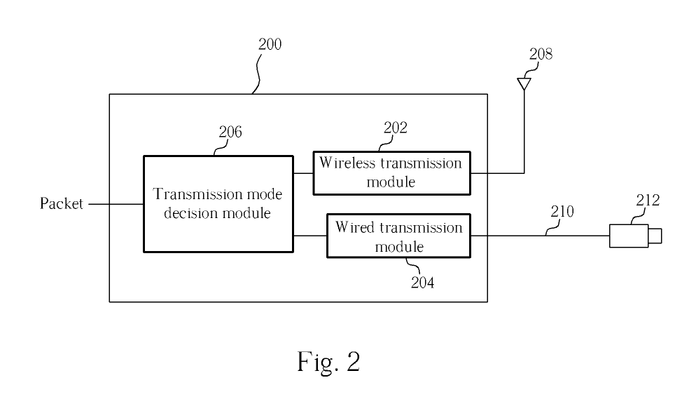

In order to realize the flow 10, please refer to FIG. 2. FIG. 2 illustrates a functional block diagram of a control chip 200 for exchanging signals between an input device of a computer system and the computer system itself through a wired communication and a wireless communication. As previously mentioned, the input device can be a keyboard, a mouse, or other equivalent electronic input device of the computer system. The control chip 200 comprises a wireless transmission module 202, a wired transmission module 204, and a transmission mode decision module 206. The wireless transmission module 202, which can be 27 MHz or 2.4 GHz, is capable of exchanging signals with the computer system through an antenna 208, and the wired transmission module 204 is capable of exchanging signals with the computer system through a wire 210 and a terminal 212. The transmission mode decision module 206 exchanges signals with the computer system through the wired transmission module 204 when the wired transmission exchanges signals with the computer system through the wire 210 and the terminal 212, and when the wired transmission module 204 cannot exchange signals with the computer system through the wire 210 and the terminal 212, the transmission mode decision module 206 then exchanges signals with the computer system through the wireless transmission module 202. In another words, the transmission mode decision module 206 transmits packets received to the computer system through the wired transmission module 204 when the wired transmission module 204 exchanges signals with the computer system through the wire 210 and the terminal 212, then the operational mode of the input device can be of the same as a wired input device (such as a wired mouse or a wired keyboard). Otherwise, if the wire 210 is faulty or the terminal is not accurately connected to the computer system, then the transmission mode decision module 206 transmits packets to the computer system through the wireless transmission module 202 via the antenna 208, and the operational mode of the input device can be of the same as a wireless input device (such as a wireless mouse or a wireless keyboard). Therefore, the transmission mode decision module 206 is capable of selecting a transmission module to connect to the computer system according to the connection status of the wired transmission module 204 and the computer system.

In addition, when operating under the wireless transmission mode (for example a wireless mouse or a wireless keyboard), the input device cannot obtain a power supply from the computer system through the physical cable, therefore an independent power supply device is required. If the power supply device within the input device operating in the wireless transmission mode has no power or has malfunctioned, then the input device cannot operate normally. Furthermore, under some circumstances, even though the power supply device is operating normally, the input device operating in the wireless transmission mode may not operate normally. For example, when the wireless signal outputted by the input device is affected by the metal shield effect, this causes the signals to be absorbed by the metal and the signal cannot be transmitted to the computer system. Furthermore, the wireless signals can also be interfered with by the same frequency signal that can cause the input device to malfunction. Through the present invention, the user can insert the wire into the computer system when the input device cannot operate normally in the wireless transmission mode such that the operational mode can be switched from the wireless transmission mode into the wired transmission mode.

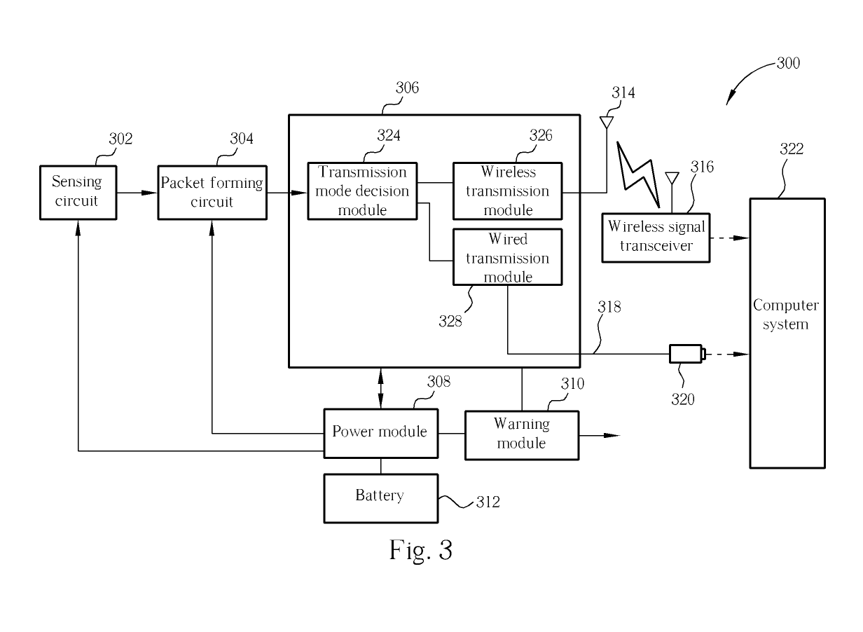

Please refer to FIG. 3. FIG. 3 illustrates a functional block diagram of a signal process device 300 for exchanging signals between an input device of a computer system and the computer system through a wired communication and a wireless communication. The input device can be a keyboard, a mouse or other equivalent electronic input device of the computer system. The signal process device 300 comprises a sensing circuit 302, a packet forming circuit 304, a control chip 306, a power module 308, a warning module 310, a battery 312, an antenna 314, a wireless signal transceiver 316, a wire 318 and a terminal 320. A sensing circuit 302 is capable of detecting data received by the input device, and the packet forming circuit is capable of forming and transmitting a plurality of packets from the data detected by the sensing circuit to the control chip 306. The control chip 306 comprises a transmission mode decision module 324, a wireless transmission module 326 and a wired transmission module 328, the operation of the control chip 306 is similar to the control chip of FIG. 2. Therefore when the wired transmission module 328 connects with a computer system 322 through the wire 318 and the terminal 320 (when the terminal is inserted into the computer system), the control chip 306 then transmits the packets outputted by the packet forming circuit 304 through the wired transmission module to the computer system 322 via the wire 318 and the terminal 320. On the contrary, when the terminal 320 is not inserted into the computer system 322, the control chip 306 transmits the packets outputted by the packet forming circuit 304 through the wireless transmission module via the antenna in a wireless manner to the wireless signal transceiver 316 so that the data received by the input device can be displayed on a screen of the computer system 322. Furthermore, the power module 308 provides power required by the signal processing device 300. When the signal processing device 300 operates in the wireless transmission mode, the power module 308 can output power from the battery 312 to each component of the signal processing device 300, and when the signal processing device 300 operates in the wired transmission mode, the power module 308 then outputs power received from the computer system 322 to each component of the signal process device 300 to prevent consumption of power from the battery 312. If the battery 312 is a rechargeable battery, then the power module 308 of the present invention can further recharge the battery 312 in the wired transmission module. Therefore, when the power level of the input device is weak, the user is simply required is to insert the terminal 320 into the computer system 322, then the input device will function normally again, and the chargeable battery within the input device can also be charged. In FIG. 3, the warning module 310 is capable of sending out a warning when the input device cannot function normally. For example, when the power level of the input device is weak, the metallic shield or other similar signal frequency affecting the input device or when the terminal is not connected accurately with the computer system, the warning module 310 is capable of outputting different warning signals such as flashing indicator, an alarm, a vibration or even displaying letters on the screen of the computer system, hence the user can take appropriate actions to maintain the normal function of the signal processing device 300.

Therefore, when the wired transmission module 328 connects with the computer system 322 through the wire 318 and the terminal 320, the signal processing device 300 exchanges signals with the computer system 322 through the wired communication and power is provided by the computer system and at the same time the chargeable battery can be charged. On the contrary, when the wired transmission module 328 cannot connect with the computer system 322, then the signal processing device 300 will exchange signals with the computer system 322 through the wireless communication and power to each component will be provided by the internal power. Furthermore, when the signal processing device is not operating properly, the warning module 310 will send out a warning signal to remind the user. Otherwise, when manufacturing the signal processing device 300, the sensing circuit 302, the packet forming circuit 304 and the control chip 306 can either be combined into a package or the sensing circuit 302, the packet forming circuit 304 and the control chip 306 can be realized in different packages.

In the present invention, the signal processing device 300 is utilized to realize the transmission mode of the input device for selectively switching to either the wired communication or the wireless communication, those skilled in the art can apply appropriate variation to the art and thus it will not be further mentioned. Take the mouse for example, the signal processing device 300 can provide a smoother and better operation when the wire of the mouse is inserted into the computer system and hence also charges the rechargeable battery; and when the wire of the mouse is unplugged, the mouse then operates in the wireless mode to provide more freedom and convenience for the user. Similarly, for the keyboard, when the wire is being unplugged from the computer system, the signal processing device 300 can also provide more freedom and convenience.

The wire 318 can be designed for insertion into the wired transmission module 328 through another terminal, or the wire 318 can be kept within the input device in a retractable manner. The terminal 320 and the wireless signal transceiver 316 can be of formats like a PS/2 or USB interface. Furthermore, the terminal 320 and the wireless signal transceiver 316 can be combined into a circuit.

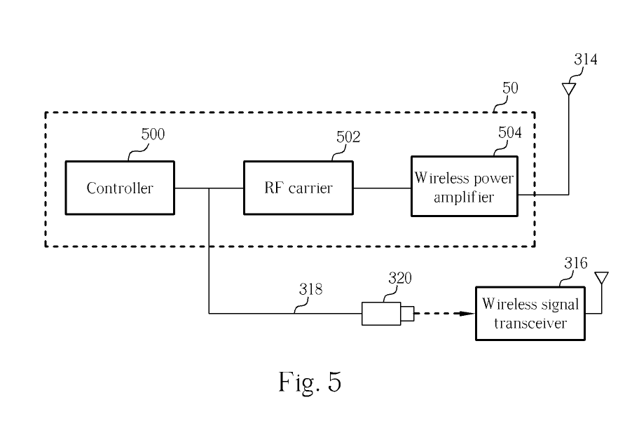

In FIG. 3, the signal outputted by the wireless transmission module 326 can also be transmitted through a physical cable. For example, please refer to FIG. 5 and at the same time as FIG. 3. FIG. 5 illustrates a diagram of a wireless transmission module 50 according to another embodiment of the wireless transmission module 326 of FIG. 3. The wireless transmission module, which can be 27 MHz or 2.4 GHz, comprises a controller 500, an RF carrier 502, and a wireless power amplifier 504. When the wireless transmission module 50 is utilized, the controller 50 is capable of transmitting radio signals through the RF carrier 502 and the wireless power amplifier 504 via the antenna 314 to the surrounding area, or the controller 50 is capable of transmitting radio signals through the wire 318 via the terminal to the wireless signal transceiver 316. Therefore, through the wireless transmission module 50, the present invention is capable of exchanging radio signals through the antenna 314, or exchanging radio signals with the wireless signal transceiver 316 through the wire 318 and the terminal 320.

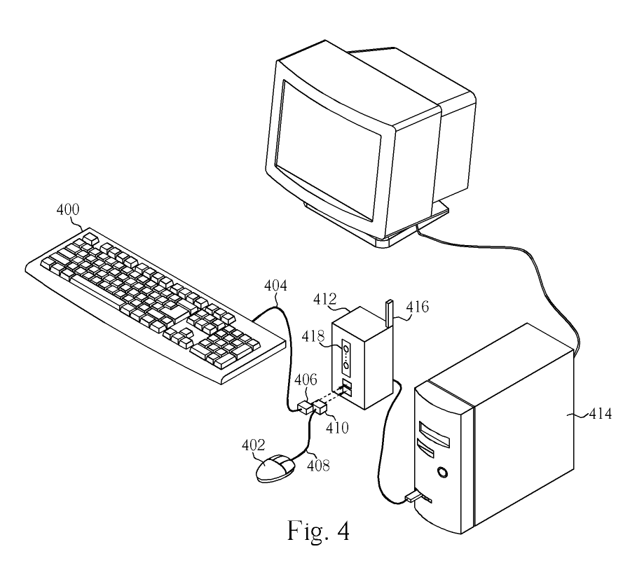

Please refer to FIG. 4. In FIG. 4, when a keyboard 400 and a mouse 402, according to the input device of the present invention, exchange signals with a mainframe 414 through a physical cable in the wired communication mode, the mainframe 414 provides power and also charges the rechargeable battery. On the contrary, when the keyboard 400 and the mouse 402 cannot exchange signals with the mainframe 414, the keyboard 400 and the mouse 402 will operate in the wireless communication mode, and power will be provided by the battery. In FIG. 4, a transceiver 412 combines the functions of the wired and wireless communication, when a terminal 406 of the keyboard 400 is inserted into the transceiver 412, the transceiver 412 will exchange signals with the keyboard 400 through a wire 404, and when the terminal 406 is unplugged, the transceiver 412 will exchange signals with the keyboard 400 through an antenna 416 in the wireless communication. Similarly, when a terminal 410 of the mouse 402 is inserted into the transceiver 412, the transceiver 412 will exchange signals with the mouse 402 through the antenna in the wireless communication. Furthermore, the transceiver 412 further comprises a plurality of indicators 418 for indicating the operation status such as normal operation, a weak battery, interference, or a long distance. The wire 404 and a wire 408 can be connected to the keyboard 400 and the mouse 402 in a plug manner, or can be stored within the keyboard 400 and the mouse 402 in a retractable manner. Those skilled in the art can apply appropriate variation to the application of FIG. 4, this will not further be mentioned.

In conclusion, the present invention provides a method for and related apparatus capable of exchanging signals with a computer through a wired and wireless communication in an input device of the computer system. When the input device is connected to the computer system through a wire, the input device will operate in a wired transmission mode and power is provided by the computer system and at the same time, a rechargeable battery within the input device will be charged. Furthermore, when the input device cannot connect to the computer system through the wire, the input device switches to a wireless transmission mode, and power is then provided by an internal power. In this way, a user is capable of selectively switching to different operation modes according to the current requirement. Therefore, the present invention not only overcomes the defects of the conventional wireless and wired input devices but also retains the advantages of the wireless and wired input devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control chip for exchanging signals with a computer system through a wired and wireless communication in an input device of the computer system, comprising:
a wireless transmission module for exchanging signals with the computer system through the wireless communication;
a wired transmission module for exchanging signals with the computer system through a wire; and
a transmission mode decision module for selecting a transmission module from either the wireless transmission module or the wired transmission module to exchange signals with the computer system according to a control signal.

2. The control chip of claim 1 wherein the transmission mode decision module, according to the control signal, is capable of exchanging signals with the computer system through the wired transmission module when the wired transmission module exchanges signals with the computer through the wire, and the transmission mode decision module is also capable of exchanging signals with the computer through the wireless transmission module when the wired transmission module is unable to exchange signals with the computer system through the wire.

3. The control chip of claim 1 wherein the control signal is generated from the input device.

4. The control chip of claim 1 wherein the wireless transmission module is further coupled to an antenna.

5. The control chip of claim 1 wherein the wired transmission module exchanges signals with the computer system through the wire and a PS/2 connection port.

6. The control chip of claim 1 wherein the wired transmission module exchanges signals with the computer system through the wire and a USB connection port.

7. The control chip of claim 1 wherein the wired transmission module exchanges signals of wireless transmission standards with the computer system through the wire.

8. The control chip of claimi wherein the input device is a mouse.

9. The control chip of claim 1 wherein the input device is a keyboard.

10. A signal processing device for exchanging signals with a computer system through a wired and wireless communication in an input device of the computer system, comprising:
a sensing circuit for determining data received by the input device;
a packet forming circuit coupled to the sensing circuit for forming a plurality of packets according to signals outputted from the sensing circuit; and
a control chip coupled to the packet forming circuit for transmitting the plurality of packets outputted from the packet forming circuit to the computer system, the control chip comprising:
a wireless transmission module for exchanging signals with the computer system through the wireless communication;
a wired transmission module for exchanging signals with the computer system through a wire; and
a transmission mode decision module for selecting a transmission module from either the wireless transmission module or the wired transmission module to exchange signals with the computer system according to a control signal.

11. The signal processing device of claim 10 further comprising a package for packaging the sensing circuit and the packet forming circuit.

12. The signal processing device of claim 10 further comprising a package for packaging the sensing circuit, the packet forming circuit and the control chip.

13. The signal processing device of claim 10 wherein the transmission mode decision module, according to the control signal, is capable of transmitting the plurality of packets outputted from the packet forming circuit to the computer system through the wired transmission module when the wired transmission module exchanges signals with the computer system through the wire, and the transmission mode decision module is also capable of transmitting the plurality of packets outputted from the packet forming circuit to the computer system through the wireless transmission module when the wired transmission module is unable to exchange signals with the computer system through the wire.

14. The signal processing device of claim 10 wherein the control signal is generated from an input device.

15. The signal processing device of claim 10 wherein the wireless transmission module further comprises an antenna.

16. The signal processing device of claim 10 wherein the wired transmission module exchanges signals with the computer system through the wire and a PS/2 connection port.

17. The signal processing device of claim 10 wherein the wired transmission module exchanges signals with the computer system through the wire and a USB connection port.

18. The signal processing device of claim 10 further comprising a power module for receiving power of the computer system when the wired transmission module exchanges signals with the computer system through the wire and providing the power received to an input device, and the power module for providing power to the input device from an internal power when the wired transmission module is unable to exchange signals with the computer system through the wire.

19. The signal processing device of claim 18 wherein the power module further comprises a charger for charging a rechargeable battery through the wire receiving the power of the computer system when the wired transmission module exchanges signals with the computer system through the wire.

20. The signal processing device of claim 10 further comprising a warning module for outputting a warning signal according to the operation status of the input device.

21. The signal processing device of claim 10 further comprising a wireless signal transceiver coupled to the computer system for exchanging signals with the wireless transmission module through the wireless communication.

22. The control chip of claim 10 wherein the wired transmission module exchanges signals of wireless transmission standards with the computer system through the wire.

23. The control chip of claim 10 wherein the input device is a mouse.

24. The control chip of claim 10 wherein the input device is a keyboard.

25. An input device capable of exchanging signals with a computer system through a wired and wireless communication, the input device comprising:
a housing;
a sensing circuit installed within the housing for determining data received by the input device;
a packet forming circuit installed within the housing and coupled to the sensing circuit for forming a plurality of packets according to signals outputted from the sensing circuit;
a control chip installed within the housing and coupled to the packet forming circuit for transmitting the plurality of packets outputted from the packet forming circuit to the computer system, the control chip comprising:
a wireless transmission module for exchanging signals with the computer system through the wireless communication;
a wired transmission module for exchanging signals with the computer system through a wire; and
a transmission mode decision module coupled to the wireless transmission module and the wired transmission module for selecting a transmission module from either the wireless transmission module or the wired transmission module to exchange signals with the computer system according to a control signal;
an antenna installed within the housing and coupled to the wireless transmission module; and
a power module installed within the housing for providing power.

26. The input device of claim 25 wherein the transmission mode decision module, according to the control signal, is capable of transmitting the plurality of packets outputted from the packet forming circuit to the computer system through the wired transmission module when the wired transmission module exchanges signals with the computer system through the wire, and the transmission mode decision module is also capable of transmitting the plurality of packets outputted from the packet forming circuit to the computer system through the wireless transmission module when the wired transmission module is unable to exchange signals with the computer system through the wire.

27. The signal processing device of claim 25 wherein the control signal is generated from the input device.

28. The input device of claim 25 wherein the power module receives power of the computer system when the wired transmission module exchanges signals with the computer system through the wire and provides the power received to an input device, and the power module provides power to the input device from an internal power when the wired transmission module is unable to exchange signals with the computer system through the wire.

29. The input device of claim 28 wherein the internal power is a battery.

30. The input device of claim 29 wherein the battery is connected externally.

31. The input device of claim 29 wherein the battery is a rechargeable battery.

32. The input device of claim 31 wherein the power module further comprises a charger for charging the battery through the wire receiving the power of the computer system when the wired transmission module exchanges signals with the computer system through the wire.

33. The input device of claim 25 further comprising a plug installed on the housing and coupled to the wired transmission module for attaching the wire.

34. The input device of claim 25 wherein the wire is capable of being rolled into the housing.

35. The input device of claim 25 wherein the wire transmission module exchanges signals with the computer system through the wire and a PS/2 connection port.

36. The input device of claim 25 wherein the wired transmission module exchanges signals with the computer system through the wire and a USB connection port.

37. The input device of claim 25 further comprising a warning module for outputting a warning signal according to the operation status of the input device.

38. The input device of claim 37 wherein the warning module outputs the warning signal through a light device.

39. The input device of claim 37 wherein the warning module outputs the warning signal through a speaker.

40. The input device of claim 37 wherein the warning module outputs a warning signal through a screen of the computer.

41. The input device of claim 37 wherein the warning module outputs a warning signal through a vibrator within the housing.

42. The input device of claim 25 further comprising a wireless transceiver coupled to the computer system for exchanging signals with the wireless transmission module through the wireless communication.

43. The input device of claim 25 further comprising a signal receiving module coupled to the computer system through a connection interface, the signal receiving module comprising:
a wired transceiver for exchanging signals with the wired transmission module;
a wireless transceiver for exchanging signals with the wireless transmission module; and
a transceiver selector coupled to the wired transceiver and the wireless transceiver for guiding the wired transceiver and the computer system when the wired transmission is coupled to the wired transceiver through the wire, and the transceiver selector for guiding the wireless transceiver and the computer system when the wired transmission module is unable to be coupled to the wired transceiver through the wire.

44. The input device of claim 43 wherein the wired transceiver comprises a plug for attaching the wire.

45. The input device of claim 43 wherein the connection interface is a PS/2 connection port.

46. The input device of claim 43 wherein the connection interface is a USB connection port.

47. The control chip of claim 25 wherein the wired transmission module exchanges signals of wireless transmission standards with the computer system through the wire.

48. The input device of claim 25 wherein the input device is a mouse.

49. The input device of claim 25 wherein the input device is a keyboard.

50. A method of exchanging signals between an input device and a computer system through a wireless communication and a wired communication, the method comprising:
determining whether the input device is connected to the computer system through a wire; and
exchanging signals with the computer system through the wireless communication when the input device is not connected to the computer system through the wire.

51. The method of claim 50 further comprising exchanging signals with the computer system through the wire when the input device connects with the computer through the wire.

52. The method of claim 51 further comprising determining an interface format of the wire when the wire exchanges signals with the computer system.

53. The method of claim 51 further comprising determining whether the connection of the input device and the computer system through the wire is being disconnected when the wire is exchanging signals with the computer system.

54. The method of claim 53 further comprising exchanging signals with the computer system through the wireless communication when the input device disconnects with the computer system through the wire.

55. The method of claim 51 further comprising exchanging signals of wireless transmission standards with the computer system through the wire when the input device connects with the computer system through the wire.

56. The method of claim 50 further comprising charging the input device when the wire exchanges signals with the computer system.

57. The method of claim 50 wherein the input device is a mouse.

58. The method of claim 50 wherein the input device is a keyboard.
